(19) United States
(12) Patent Application Publication
(10) Pub. No.: US 2015/0264791 A1
(43) Pub. Date: Sep. 17, 2015

(54) Method and Apparatus for Generating Radiation

(71) Applicant: ASML Netherlands B.V., Veldhoven (NL)

(72) Inventors: Andrey Nikipelov, Eindhoven (NL); Frederik Dijksman, Weert (NL); Mikhailovich Yakunin, Mierlo (NL)

(73) Assignee: ASML Netherlands B.V., Veldhoven (NL)

(21) Appl. No.: 14/418,366

(22) PCT Filed: Jul. 5, 2013
(86) PCT No.: PCT/EP2013/064258

§ 371 Date: Jan. 29, 2015

Related U.S. Application Data
(60) Provisional application No. 61/678,560, filed on Aug. 1, 2012.

(51) Int. Cl. H05G 2/00

(52) U.S. Cl. CPC H05G 2/008; H05G 2/003

(57) ABSTRACT

A method for generating radiation. Directing a first body from a first location. Directing a second body from a second, different location. The first body and second body being used to form a target at a plasma formation location. At least one of the first body and second body comprising a fuel for use in generating a radiation generating plasma. Directing initiating radiation at the target at the plasma formation location to generate a radiation generating plasma from the target.

### CROSS-REFERENCE TO RELATED APPLICATIONS

This application claims the benefit of U.S. provisional application 61/678,560 which was filed on 1 Aug. 2012 and which is incorporated herein in its entirety by reference.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k₁.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm. It has further been proposed that EUV radiation with a wavelength of less than 10 nm could be used, for example within the range of 5-10 nm such as 6.7 nm or 6.8 nm. Such radiation is termed extreme ultraviolet radiation or soft x-ray radiation. Possible sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a radiation source collector module for containing the plasma. The plasma may be created, for example, by directing a laser beam (i.e., initiating radiation) at a fuel, such as particles (i.e., droplets) of a suitable fuel material (e.g., tin, which is currently thought to be the most promising and thus likely choice of fuel for EUV radiation sources), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector (sometimes referred to as a near normal incidence radiation collector), which receives the radiation and focuses the radiation into a beam. The radiation collector may have any other suitable form. The source collector module may include an enclosing structure or chamber arranged to provide a vacuum environment to support the plasma. Such a radiation system is typically termed a laser produced plasma (LPP) source. In an alternative system, which may also employ the use of a laser, radiation may be generated by a plasma formed by the use of an electrical discharge—a discharge produced plasma (DPP) source.

As discussed above, a laser beam is directed at a target of a suitable fuel material to generate a radiation generating plasma. However, it has been proposed to direct an initial (e.g., lower energy) laser pulse at the target, prior to the directing of the main beam at the target. The initial (or first, or pre-pulse) laser pulse may be configured to, for example, in some way change a property of the target to optimise the radiation generation process in some way. For example, the optimisation may be such that a larger amount of EUV radiation is generated for a given target, and/or such that the radiation is preferentially directed in a certain direction, and/or such that debris resulting from the generation of the radiation generating plasma is directed in a certain direction. Typically, the initial laser pulse will heat the target and/or change the shape of the target, either or both of which may assist in the aforementioned optimisation.

Although the use of a first, lower energy laser pulse may indeed optimise the generation of radiation, there are still drawbacks associated with the use of such an initial laser pulse. For example, one drawback is that the initial laser pulse may, when incident on the target, cause particulate contamination to be generated in the form of a large number of nanometre-sized particles of fuel. These particles may be small and fast enough to overcome any buffer gas or other mitigation arrangement that is present, which might otherwise prevent the particles from coming into contact with and contaminating the collector of the radiation source, or the like. Alternatively or additionally, the generation of such particles results in there being less material for use in the generation of the radiation generating plasma, which may reduce the conversion efficiency of the radiation generating process as a whole (even if only slightly). Furthermore, an initial laser pulse may only be used to change the shape of the target in a limited number of ways, for example, typically relating to the flattening of a droplet-shaped target into a disc-like-shaped target. Finally, the use of an initial laser pulse will still require a significant amount of energy, and may add design complexity to the laser arrangement as a whole that is used in the generation of the radiation generating plasma.

### SUMMARY

It is desirable to obviate or mitigate at least one problem of the prior art, whether identified herein or elsewhere, or to provide an alternative to existing apparatus or methods.

According to a first aspect of the present invention, there is provided a method of generating radiation, the method comprising: directing a first body from a first location; directing a second body from a second, different location; the first body and second body being used to form a target at a plasma formation location, at least one of the first body and second body comprising a fuel for use in generating a radiation generating plasma; directing initiating radiation at the target at the plasma formation location to generate a radiation generating plasma from the target.

The first body and second body may be directed to cause a collision between the first body and the second body, to form the target. The nature of the collision may be controlled to control the shape (e.g., concave, convex, flattened, toroidal) or make-up (e.g., a plurality of smaller bodies) of the target.

The first body and second body may be directed such that trajectories of a centre of the first body and a centre of the second body substantially coincide in space and time at a collision location.

A flattened (e.g., disc-like) body may be formed from the collision, the flattened body forming the target. The initiating radiation may be directed at the target such that the initiating radiation is incident on the flattened surface.

The first body and second body may be directed such that the flattened surface of the flattened body extends in a direction substantially perpendicular to: a trajectory of initiating radiation directed at the flattened body; and/or an optical axis of a radiation collector configured to collect radiation generated by the radiation generating plasma.

The first body and second body may be directed such that trajectories of a centre of the first body and a centre of the second body are offset in space and/or time at a collision location.

A plurality of bodies, smaller than the first body and/or second body, may be formed from the collision, the plurality of bodies forming the target.

One or more strands or filaments may be formed from the collision, the one or more strands or filaments forming the target.

The plurality of bodies may be aligned in a substantially linear manner.

The first body and second body may be directed such that the plurality of bodies are aligned in a direction substantially parallel to: a trajectory radiation directed at the plurality of bodies; and/or an optical axis of a collector configured to collect radiation generated by the radiation generating plasma.

With respect to the initiating radiation directed at the target, the collision may form a substantially concave target, a substantially convex target, or a substantially toroidal target. The collision may form a target with a substantially flattened shape (with respect to the shape of the first body and/or second body).

The first body and second body may be directed such that the target comprises the first body and second body located substantially adjacent to one another. The make-up of the target can thus be controlled by directing bodies to specific locations at the plasma formation location.

The first body and second body may be directed such that the first body and second body are, at the plasma formation location, aligned in a direction substantially parallel to: radiation directed at the first body and the second body; and/or an optical axis of a collector configured to collect radiation generated by the radiation generating plasma.

The first body and/or second body may comprise a droplet of fluid.

The first body and the second body may comprise (e.g., a droplet of) fuel for use in generating a radiation generating plasma.

The first body may be at (or have) a first temperature, and the second body may be at (or have) a second, different temperature, for example at a collision location of the bodies.

The first body may comprise a first material, and the second body comprises a second, different material.

The first body may comprise a material that has a boiling temperature that is lower than a temperature of the second body, for example at a collision location of the bodies.

The first body and/or second body may comprise a material that is substantially transparent to the radiation that is to be generated by the radiation generating plasma.

The method may further comprise directing a third body from a third, different location, the third body also being used to form the target at the plasma formation location.

A second implementation of the method may also be performed substantially simultaneously, thereby generating a second target which together with the target forms a composite target at the plasma formation location.

The method may further comprise using active control of properties of the bodies to adjust the shape or make-up of the target.

According to a second aspect of the present invention, there is provided a lithographic method, comprising: generating radiation according to the method of any preceding claims; and using the generated radiation to apply a pattern to a substrate.

According to a third aspect of the present invention, there is provided a radiation source comprising: a first configuration for directing a first body from a first location; a second configuration for directing a second body from a second, different location; the first body and second body being, in use, used to form a target at a plasma formation location, at least one of the first body and second body comprising a fuel for use in generating a radiation generating plasma; a secondary (i.e., a different) radiation source configured to direct initiating radiation at the target at the plasma formation location to generate, in use, a radiation generating plasma from the target.

The first configuration and/or the second configuration may comprise a droplet generator, each configured to generate a stream of droplets.

The radiation source might further comprise a radiation collector for collecting radiation generated by the radiation generating plasma at a plasma formation location. The radiation collector may be arranged to directing at least a portion of the generated radiation to a focal point.

According to a fourth aspect of the present invention, there is provided a lithographic apparatus comprising, or in connection with (e.g., physically connected together, or able to receive radiation from), the radiation source of the third aspect of the invention.

The lithographic apparatus may additionally comprise one or more of the following: an illumination system for providing and/or conditioning a radiation beam; a patterning device for imparting a radiation beam with a pattern in its cross-section; a substrate holder for holding a substrate; and/or a projection system for projecting the patterned radiation beam onto a target portion of the substrate.

According to a fifth aspect of the invention, there is provided an apparatus comprising, or in connection with (e.g., physically connected together, or able to receive radiation from), the radiation source according to the present invention. The apparatus may be an inspection tool (e.g., a patterning device inspection tool), or any apparatus that uses radiation for reasons other than lithography (e.g., illumination, inspection, experimentation, probing, or the like).

One or more aspects of the invention may, where appropriate to one skilled in the art, be combined with any one or more other aspects described herein, and/or with any one or more features described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus according to an embodiment of the invention;

FIG. 2 is a more detailed view of the apparatus of FIG. 1, including an LPP source collector module;

FIG. 3 schematically depicts a principle associated with proposed methods of generating radiation;

FIG. 4 schematically depicts a radiation source according to an embodiment of the present invention;

FIGS. 5 to 7 schematically depict different target shapes that may be realised using the radiation source as shown in and described with reference to FIG. 4;

FIGS. 8 to 11 schematically depict how at least one of the target shapes shown in and described with reference to FIGS. 5 and 6 may be created and used in the generation of a radiation generating plasma;

FIG. 12 schematically depicts a method of generating a target shape as shown in and described with reference to FIG. 7, in accordance with an embodiment of the present invention;

FIG. 13 schematically depicts a method of generating radiation using a target with a different make-up, in accordance with another embodiment of the present invention; and

FIGS. 14 and 15 schematically depict alternative arrangements for achieving substantially the same target make-up as shown in and described with reference to FIG. 13.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

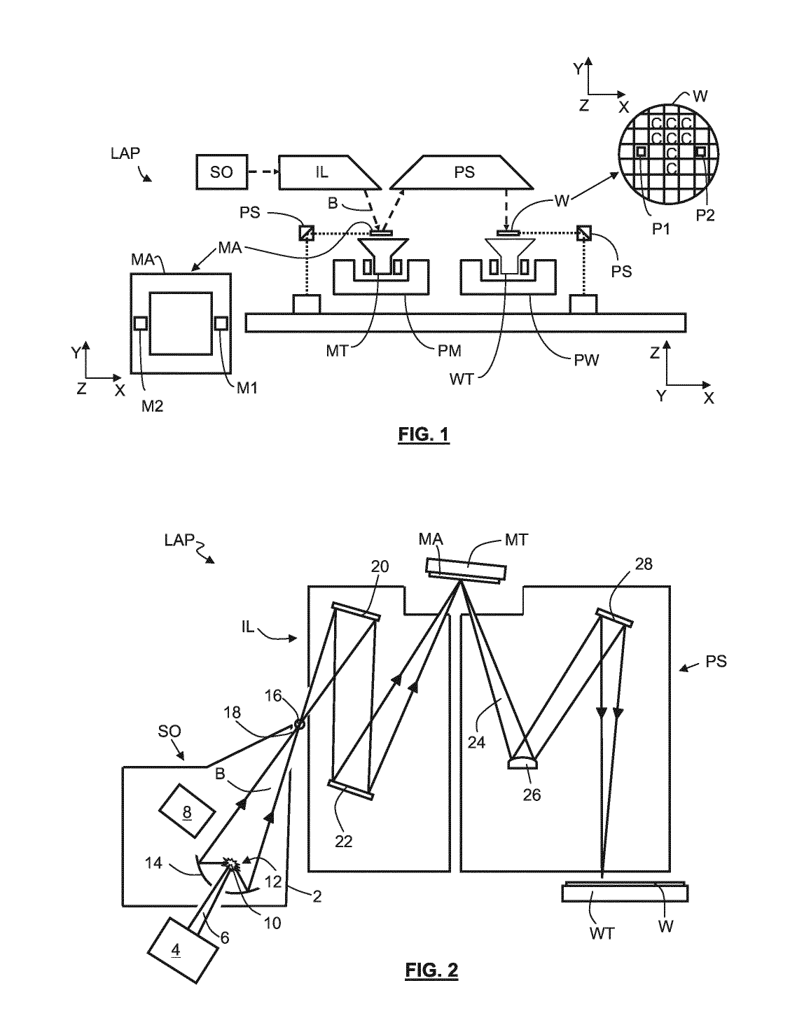

FIG. 1 schematically depicts a lithographic apparatus LAP including a source collector module SO according to an embodiment of the invention. The apparatus comprises: an illumination system (illuminator) IL configured to condition a radiation beam B (e.g., EUV radiation); a support structure (e.g., a mask table) MT constructed to support a patterning device (e.g., a mask or a reticle) MA and connected to a first positioner PM configured to accurately position the patterning device; a substrate table (e.g., a wafer table) WT constructed to hold a substrate (e.g., a resist-coated wafer) W and connected to a second positioner PW configured to accurately position the substrate; and a projection system (e.g., a reflective projection system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since gases may absorb too much radiation. A vacuum environment may therefore be provided to the whole beam path with the aid of a vacuum wall and vacuum pumps.

As here depicted, the apparatus is of a reflective type (e.g., employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a fuel stream generator for generating a stream of fuel and/or a laser (neither of which are shown in FIG. 1), for providing the laser beam for exciting the fuel. The resulting plasma emits output radiation, e.g., EUV radiation, which is collected using a radiation collector, disposed in the source collector module. The laser and/or fuel stream generator and the collector module (often referred to as a source collector module), may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil mirror devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The depicted apparatus could be used in at least one of the following modes:

1. In step mode, the support structure (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed.
2. In scan mode, the support structure (e.g., mask table) MT and the substrate table WT are scanned synchronously while a pattern imparted to the radiation beam is projected onto a target portion C (i.e., a single dynamic exposure). The velocity and direction of the substrate table WT relative to the support structure (e.g., mask table) MT may be determined by the (de-)magnification and image reversal characteristics of the projection system PS.
3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

FIG. 2 shows the lithographic apparatus LAP in more detail, including the source collector module SO, the illumination system IL, and the projection system PS. The source collector module SO is constructed and arranged such that a vacuum environment can be maintained in an enclosing structure 2 of the source collector module.

A laser 4 is arranged to deposit laser energy via a laser beam 6 into a fuel, such as xenon (Xe), tin (Sn) or lithium (Li) which is provided from a fluid stream generator 8. Liquid (i.e., molten) tin (most likely in the form of droplets), or another metal in liquid form, is currently thought to be the most promising and thus likely choice of fuel for EUV radiation sources. The deposition of laser energy into the fuel creates a highly ionized plasma 10 at a plasma formation location 12 which has electron temperatures of several tens of electronvolts (eV). The energetic radiation generated during de-excitation and recombination of these ions is emitted from the plasma 10, collected and focused by a near normal incidence radiation collector 14 (sometimes referred to more generally as a normal incidence radiation collector). The collector 14 may have a multilayer structure, for example one tuned to reflect, more readily reflect, or preferentially reflect, radiation of a specific wavelength (e.g., radiation of a specific EUV wavelength). The collector 14 may have an elliptical configuration, having two natural ellipse focus points. One focus point will be at the plasma formation location 10, and the other focus point will be at the intermediate focus, discussed below.

A laser 4 and/or fluid stream generator 8 and/or a collector 14 may together be considered to comprise a radiation source, specifically an EUV radiation source. The EUV radiation source may be referred to as a laser produced plasma (LPP) radiation source. The collector 14 in the enclosing structure 2 may form a collector module, which forms a part of the radiation source (in this example).

A second laser (not shown) may be provided, the second laser being configured to preheat the fuel before the laser beam 6 is incident upon it. An LPP source which uses this approach may be referred to as a dual laser pulsing (DLP) source. Such a second laser may be described as providing a pre-pulse into a fuel target, for example to change a property of that target in order to provide a modified target. The change in property may be, for example, a change in temperature, size, shape or the like, and will generally be caused by heating of the target.

Although not shown, the fuel stream generator will comprise, or be in connection with, a nozzle configured to direct a stream of, for example, fuel droplets along a trajectory towards the plasma formation location 12.

Radiation B that is reflected by the radiation collector 14 is focused at a virtual source point 16. The virtual source point 16 is commonly referred to as the intermediate focus, and the source collector module SO is arranged such that the intermediate focus 16 is located at or near to an opening 18 in the enclosing structure 2. The virtual source point 16 is an image of the radiation emitting plasma 10.

Subsequently, the radiation B traverses the illumination system IL, which may include a facetted field mirror device 20 and a facetted pupil mirror device 22 arranged to provide a desired angular distribution of the radiation beam B at the patterning device MA, as well as a desired uniformity of radiation intensity at the patterning device MA. Upon reflection of the beam of radiation at the patterning device MA, held by the support structure MT, a patterned beam 24 is formed and the patterned beam 24 is imaged by the projection system PS via reflective elements 26, 28 onto a substrate W held by the wafer stage or substrate table WT.

More elements than shown may generally be present in the illumination system IL and projection system PS. Furthermore, there may be more mirrors present than those shown in the figures, for example there may be 1-6 additional reflective elements present in the projection system PS than shown in FIG. 2.

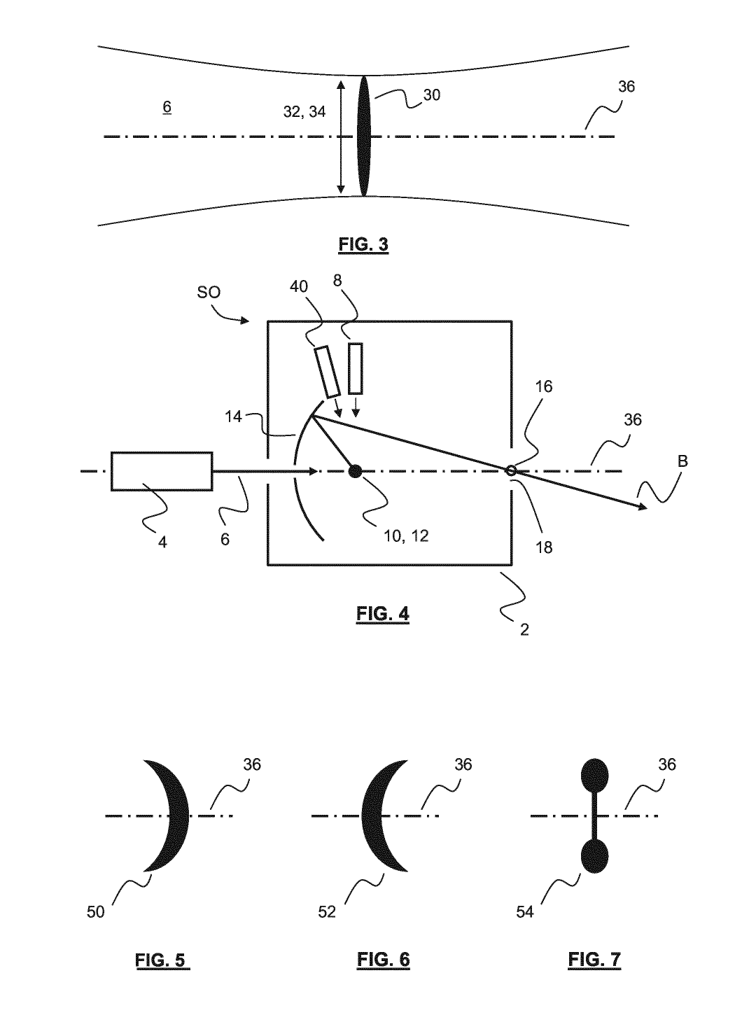

As already described above, an initial (or pre) beam (or beam pulse) of radiation may be directed at the fuel target, prior to a main beam, in order to modify the shape and/or temperature of the target. The modification will typically be such that the conversion of the fuel target into a radiation generating plasma is in some way optimised. FIG. 3 provides a diagrammatic example of such optimisation.

In FIG. 3, an initial (e.g., lower energy) pulse of laser radiation has already been directed at a substantially spherical fuel target droplet to provide a substantially flattened fuel target 30. The flattened fuel target 30 will typically have a substantially disc-like shape. There are a number of reasons as to why flattening the target (and/or a flattened target) may be desirable. A first reason is so that a diameter 32 of the flattened target 30 substantially corresponds with a laser beam waist 34 of the laser beam 6 that will be used to convert the flattened fuel target 30 into a radiation generating plasma (or at least to a greater extent than the spherical target droplet would have). This ensures that as much radiation in the laser beam 6 as possible is used in the conversion of the flattened fuel target 30 into a radiation generating plasma. This optimises the energy or dose that is required in the laser beam 6 and/or optimises the conversion of fuel material of the flattened target 30 into a radiation generating plasma. Another reason for flattening the target 30 might be to control the direction of radiation and/or debris (which might be referred to as contamination) generated in or by the radiation generating plasma, when the laser beam 6 is incident on the target 30. Specifically, the target 30 will present a flattened surface. The flattened surface of the target 30 is shown as being substantially perpendicular to an optical axis 36 of a radiation collector of the radiation source, and also substantially perpendicular to the trajectory (i.e., direction of propagation) of the laser beam 6. It has been found that this arrangement ensures that most radiation will be generated along the optical axis 36, since a flattened target will, when converted into a radiation generating plasma, usually have an anisotropic distribution of radiation which is substantially and preferentially directed along the optical axis 36. Debris that is produced might also generally have a propagation direction that is in some way parallel to the optical axis. Such knowledge can be used to control or accommodate for such debris (e.g., by the appropriate location of one or more debris or contamination traps, or some other form of mitigation arrangement—e.g., a buffer gas or the like).

Although the re-shaping of an otherwise substantially spherical fuel target may be advantageous in at least some respects, a flattened shape might not always be required, and the use of a laser beam to achieve this flattening (or, more generally, re-shaping) has associated disadvantages. At least one disadvantage is that the use of a laser beam to shape the target does not provide much flexibility in the way in which the target may be shaped. For instance, in practical terms it is thought that only a flattened target can be provided, with it being difficult or impossible to provide more other shapes with only a single laser beam. Other shapes may be advantageous. Another important disadvantage is that the initial laser pulse used to flatten the target does not simply flatten the target—particulate contamination is also generated, having a diameter of the order of nanometres. The generation of this contamination is problematic. One problem is that the contamination is difficult to stop due to its energy and size, which can result in surfaces surrounding the plasma formation location, for example the collector, becoming contaminated with such contamination. Also, the generation of such contamination reduces the fuel mass of the target that can, subsequently, be converted into radiation generating plasma, which can (however slightly) reduce the amount of radiation that can be generated therefrom.

According to an embodiment of the present invention, the abovementioned problems may be obviated or mitigated. According to the present invention there is provided a method of generating radiation, and an apparatus (i.e., a radiation source) for use in implementing that method. The method comprises directing a first body from a first location. A second body is directed from a second, different location. The first body and second body are used to form a target at a plasma formation location. At least one of the first body and second body comprises a fuel for use in generating a radiation generating plasma, with typically at least one body (usually the body comprising fuel) being in fluid (e.g., molten) form. The method further comprises directing initiating (that is, radiation sufficient to generate a plasma from the target) radiation at the target at the plasma formation location to generate, in use, a radiation generating plasma from the target.

The use of first and second bodies originating from different locations allows for a greater degree of freedom in the formation of the shape and/or make-up of the target. For instance, different bodies may come from one or more different directions to create a specifically shaped target, or a target comprising one or more bodies located adjacent to one another. This may optimise the generation of radiation, and/or allow for a greater degree of control over the propagation direction or the like of any contamination that is generated in the generation of the radiation generating plasma. Furthermore, using two bodies to form a target at a plasma formation location (e.g., as opposed to a body and a laser beam) avoids at least some of the problems associated with the use of a pre-pulse (or initial) laser beam used to modify a spherical target, as described above. One advantage is that less energy may be required in the use of two bodies, as opposed to the use of a pre-pulse laser beam. Also, the use of two bodies does not result in the generation of a large amount of small scale (e.g., nanometre-sized) particulate contamination, which might otherwise contaminate one or more surfaces of the radiation source.

Embodiments of the present invention will now be described, by way of example only, with reference to FIGS. 4 to 15. The same features appearing in different Figures have been given the same reference numerals for consistency and clarity.

FIG. 4 schematically depicts apparatus that can be used to implement the method according to an embodiment of the present invention. The apparatus shown in FIG. 4 is much the same as the apparatus already shown in and described with reference to the LPP radiation source of FIG. 2. However, in order to provide a body from a second, different location in accordance with the method described above, a second droplet generator 40 is provided in addition to the first droplet generator 8. The first droplet generator 8 and second droplet generator 40 may be located in substantially the same plane, so that any shadow caused in the generated radiation by the first droplet generator 8 (or second droplet generator 40), is not in any way added to by the presence of the second droplet generator 40 (or first droplet generator 8), which might otherwise result in a reduction in collected radiation. The collector 14 is shown as a normal incidence collector, but in other embodiments could be a grazing incidence collector, or any other suitable form of collector.

In one embodiment the first body and second body (e.g., a first droplet and second droplet) are directed towards one another to cause a collision between the first droplet and second droplet. Depending on the angle of incidence of the first droplet relative to the second droplet, the relative size of the droplets, and/or the relative speed of the droplets, the droplets may at least temporarily and at least partially coalesce to form a single, substantially unified target of a shape that is different to either of the first and second droplets (i.e., not just a different size, but a different shape). Many different shapes can be created in this way. In addition to the parameters discussed above, the exact shape may also depend on the nature of the droplets that are used (e.g., their composition, temperature, or the like). Thus, it will be appreciated that the exact requirements needed to achieve each and every specific shape may require a minor degree of experimentation, trial and error or modelling. However, it is known that the collision of two droplets can be used to form concave shapes, convex shapes, toroidal shapes, substantially flattened (e.g., disk-like) shapes, or to ensure that the target make-up comprises strands or filaments, or a plurality of smaller droplets.

FIGS. 5 to 7 schematically depict target shapes that may be achieved by the collision and at least partial coalescence of two droplets. In the Figures the optical axis 36 of the collector is also shown. For context, in each of FIGS. 5 to 7 a laser beam used to form a radiation generating plasma from each target will be incident substantially along the optical axis 36 and in a direction from left to right on the plane in which the Figures are shown. Thus, in FIG. 5 the target 50 will present a substantially concave target to the radiation that will be directed at the target. This shape may be achieved by directing a smaller droplet into a larger droplet, the smaller droplet being directed into the larger droplet at a side of the larger droplet into which the concave surface is to be provided. When laser radiation is directed at the target 50, the distribution of radiation generated by the resulting plasma may be less isotropic than, for example, radiation generated using the flattened target used in FIG. 3. Also, due to the shape of the target, more of the target material may be converted into a radiation generating plasma, increasing conversion efficiency in comparison with the flattened target shown in and described with reference to FIG. 3.

FIG. 6 shows that a target with a convex surface 52 is presented to the incoming beam of radiation. This shape may be achieved by directing a smaller droplet into a larger droplet, the smaller droplet being directed into the larger droplet at a side of the larger droplet opposite to that in which the convex surface is to be provided. Radiation generated from the resulting radiation-generating plasma will have a more isotropic distribution than, for example, the flattened target shown in and described with reference to FIG. 3. At the same time, the shape of the target may result in a lower conversion efficiency compared with the flattened target shown in and described with reference to FIG. 3.

FIG. 7 shows a toroidal shaped target 54, which may be created by providing droplets of approximately equal size. Radiation generated from the resulting radiation-generating plasma will have a more isotropic distribution than, for example, the flattened target shown in and described with reference to FIG. 3. At the same time, the shape of the target may result in a higher conversion efficiency compared with the flattened target shown in and described with reference to FIG. 3.

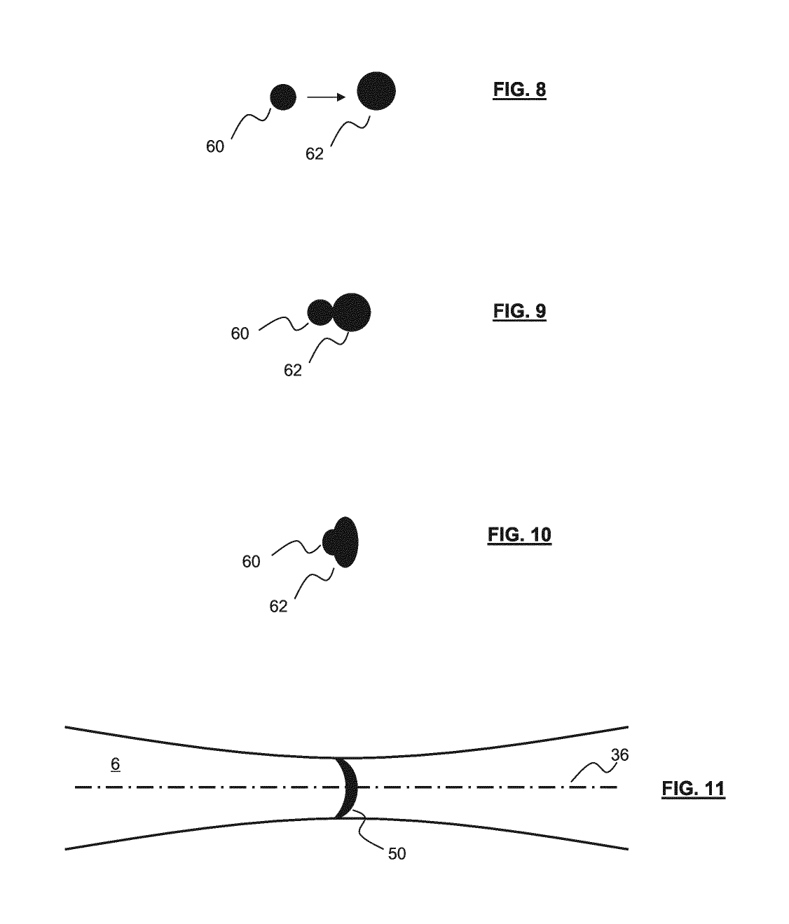

FIGS. 8 to 11 schematically depict how, for instance, the target shape shown in and described with reference to FIG. 5 may be created. FIG. 8 shows how a relatively small droplet 60 may be directed toward and into collision with a relatively large droplet 62. The large droplet 62 may be moving in substantially the same direction as the first, small droplet 60, or at least have a velocity component that is in the same direction. FIG. 9 shows that the first droplet 60 is in collision with the second, larger droplet 62. FIG. 10 shows that, as a result of the collision, the first droplet 60 and second droplet 62 are partially flattened, and at least to some extent begin to coalesce as a result of the collision. FIG. 11 shows that the material forming the first droplet 60 continues, with its momentum, into and through the second droplet 62. As the two droplets 60, 62 become one single target, the target as a whole has, at least in cross-section, a concave shape 50 as shown in and described with reference to FIG. 5. At the point when the shape of the target is as desired, for example a concave shape 50, the laser beam 6 may be triggered to be incident on the target 50 for generating a radiation generating plasma therefrom.

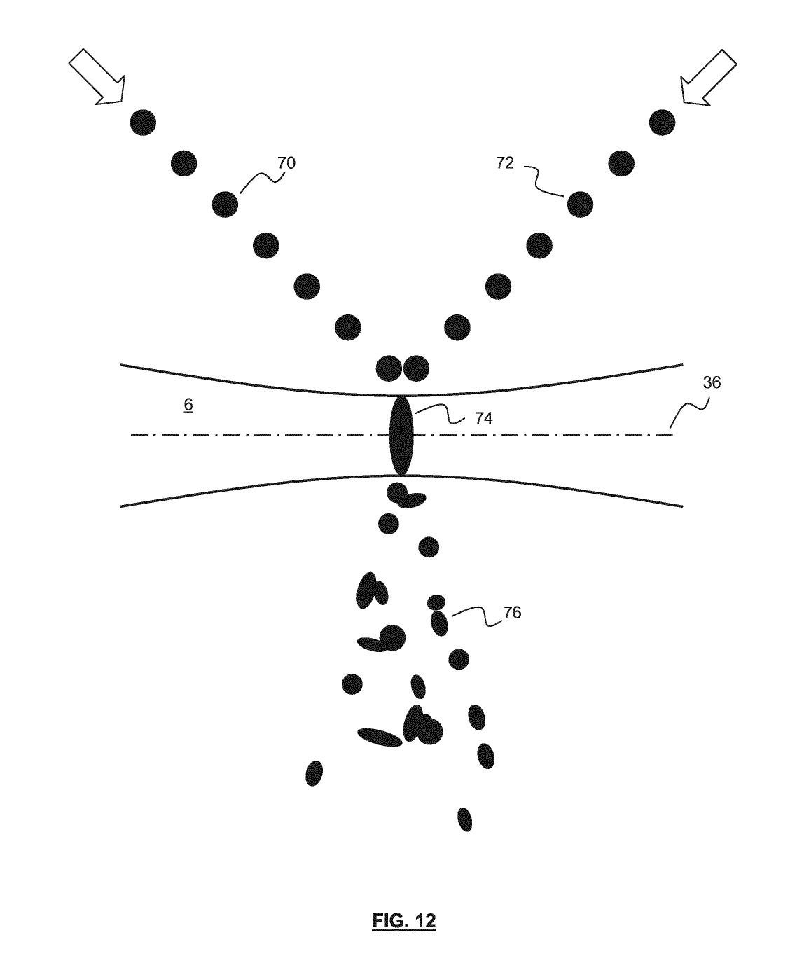

Target shapes and make-ups may be different to those shown in relation to FIGS. 5 to 10. For example, FIG. 12 shows how a flattened target (e.g., having a disk-like shape) may be formed from the collision of two droplets. A stream of first bodies 70 (e.g., droplets) is directed to collide with a stream of second bodies 72 (e.g., droplets). The directing is such that trajectories of the centre of a first droplet and a centre of a second droplet substantially coincide in space and time at a collision location. This might alternatively or additionally be described as the situation whereby if no collision took place (e.g., if the droplets could pass through one another), the centres of the first droplet and the second droplet would coincide with one another at the point of collision. Experiments have shown that such a collision results, slightly downstream of the point of collision, in a substantially flattened target which may have a disc-like shape 74.

By appropriately directing the first droplet and second droplet (or, more generally, the streams 70, 72 thereof), the properties of the flattened target 74 may be controlled, for example the orientation of the target 74 or the degree of flattening of the target 74. For example, FIG. 12 shows that the directing of the first droplets 70 and second droplets 72 is such that a flattened surface of the flattened body 74 extends in a direction substantially perpendicular to the optical axis 36 of the radiation collector, and also substantially perpendicular to the trajectory (i.e., propagation direction) of the radiation beam 6. This has the advantages already described above in relation to the proposed pre-pulse arrangement shown in and described with reference to FIG. 3. However, the embodiment according to the present invention has the advantage that no pre-pulse laser radiation is required to form the flattened target 74, and therefore no (or at least far less) particulate contamination is generated as a result.

If, for whatever reason, laser beam 6 is not directed at the flattened target 74, a rather chaotic distribution of droplets and the like 76 will be generated downstream of the collision location. However, if the laser beam 6 is directed at the flattened target 74 then a distribution of droplets and the like will not be generated downstream of the laser beam (the flattened target will have been converted into a plasma).

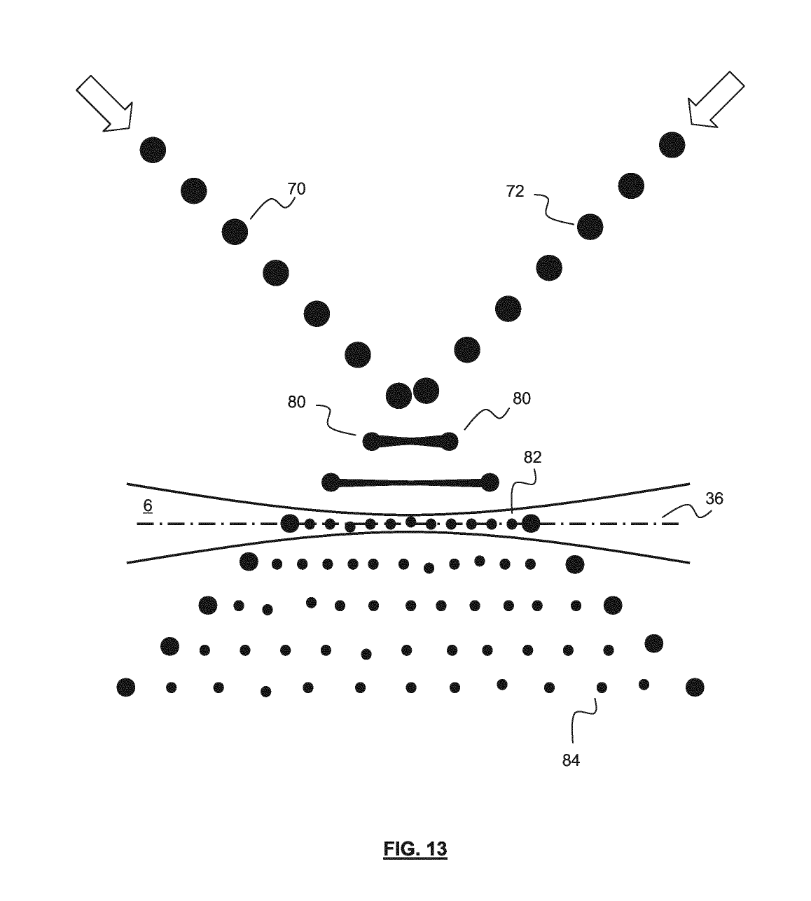

FIG. 13 schematically depicts an alternative, but related, embodiment to that already shown in and described with reference to FIG. 12. In FIG. 13 the first droplets 70 and second droplets 72 are again directed toward one another in order such that the droplets collide at a collision location. However, and subtly different to the method shown in FIG. 12, the first droplets and second droplets are now directed toward one another such that trajectories of a centre of the first droplet and a centre of the second droplet are offset in space and/or time at the collision location. In an alternative or additional description of this concept, if the first and second droplets could pass through one another, at and through the point of collision the centres of the droplets would never coincide.

In accordance the above principles, the collision is a slightly offset collision, which results in one or more droplets taking material from the other of the droplets in the collision. As shown in the Figure, this may result in the collision forming two droplets 80 (typically smaller than the original droplets 70, 72) which are initially linked to one another by a combination of material (e.g., in the form of one of more filaments or strands) from the two different bodies 70, 72 that have already collided. Over time, the material linking the two smaller droplets 80 breaks up into a plurality of droplets 82 (i.e., bodies) that are aligned in a substantially linear manner between the two smaller droplets 80. The plurality of droplets are typically smaller than the original (pre-collision) droplets 70, 72 and the smaller droplets 80 that are initially formed and linked together after the collision.

At or just after the point of break up into the plurality of droplets 82 aligned in a substantially linear manner, the laser beam 6 may be directed at the plurality of droplets 82 to form a radiation generating plasma. If, for whatever reason, laser beam 6 is not directed at the target comprising the plurality of bodies 78, the droplets will continue to spread further apart 84, and/or disintegrated in to small droplets, downstream of the collision location. However, if the laser beam 6 is directed at the target then droplets will not exist downstream of the laser beam (the target will have been converted into a plasma).

In a related embodiment, the laser may be directed at a target that, post-collision, is formed from one or more strands or filaments—i.e., before the plurality of droplets is formed.

By appropriately directing the first droplet and second droplet (or, more generally, the streams 70, 72 thereof), properties of the target 82 may be controlled, for example the orientation of the target 82 or the degree of separation of droplets constituting the target 82. For example, FIG. 13 shows that the directing of the first droplets 70 and second droplets 72 is such that the target 82 extends in a direction substantially parallel to and along the optical axis 36 of the radiation collector, and also substantially parallel to the trajectory (i.e., propagation direction) of the radiation beam 6 that is incident on the target 82.

The arrangement in FIG. 13 may be advantageous since the distribution of the plurality of droplets along the optical axis 36 of the collector and/or along and parallel to the trajectory (propagation direction) of the radiation beam 6 may ensure that the combined mass of the target is distributed in a manner which facilities more efficient conversion thereof into a radiation generating plasma. This may be due to the mass being distributed along the optical axis 36 and/or the trajectory of the laser beam 6, and/or the droplets being slightly offset from the optical axis 36 or beam 6 trajectory (which may occur naturally, post-collision), thereby filling the waist of the laser beam to a fuller extent.

Multiple implementations of the above described arrangements may be provided in the radiation source. For example, referring to FIG. 12, in addition to the streams of droplets 70, 72, two additional streams of droplets may be generated (e.g., using two. The two additional streams of droplets may be directed to collide with each other thereby forming a flattened body (e.g., having a shape and orientation which corresponds with the flattened body 74 shown in FIG. 12). Two implementations of the method may be performed substantially simultaneously, such that a composite target which comprises two axially separated flattened bodies is generated. The axially flattened bodies may for example be axially displaced along the optical axis 36. Similarly, referring to FIG. 13, two additional streams of droplets may be generated, such that the target which receives the laser beam 6 is a composite target which comprises the target 82 repeated two times (e.g., separated in the axial direction). In general, a composite target comprising two or more of the targets described above may be generated. This may for example be done by running multiple implementations of the above methods substantially simultaneously (e.g., using multiple pairs or sets of droplet generators). Parts of the composite target may be separated in the axial direction. Parts of the composite target may be substantially aligned along the optical axis 36.

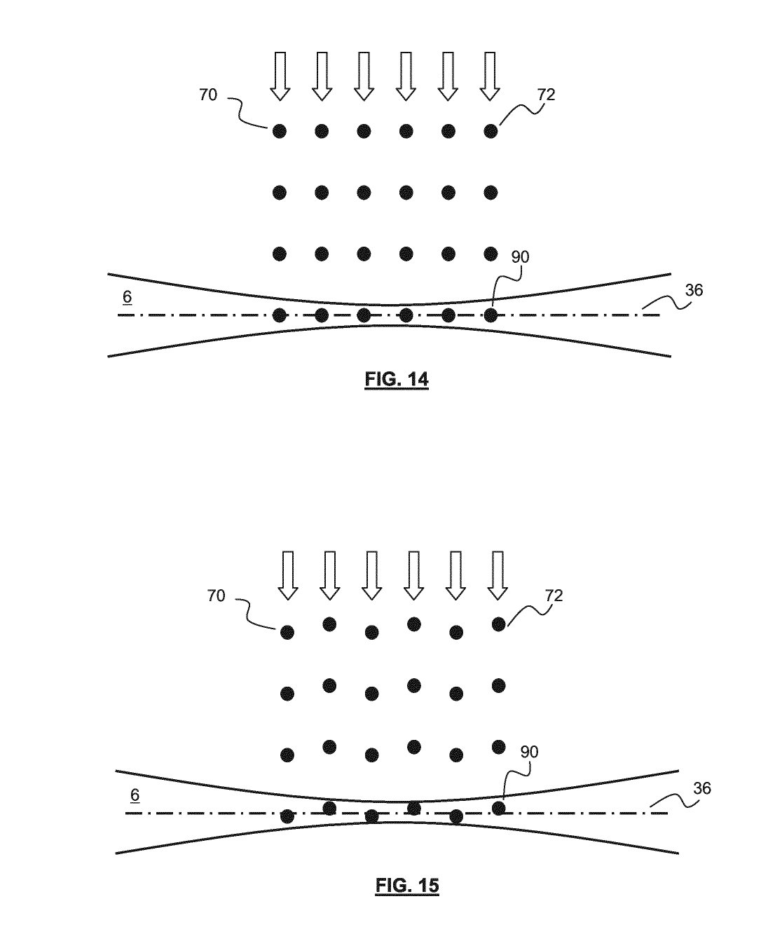

FIGS. 14 and 15 schematically depict alternative methods for forming the target (comprising a plurality of droplets) as already shown and described with reference to FIG. 13. In FIGS. 14 and 15, no collision of droplets is required to form the target 90. Instead, droplet streams 70, 72, originating from different locations, are simply directed towards a desired plasma formation location (and target formation location). The directing is such that a plurality of droplets form a substantially linear arrangement of droplets 90 located adjacent to one another.

At the plasma formation location, the laser beam 6 is directed at the plurality of droplets 90. Again, the plurality of droplets forming the target 90 may be aligned in a direction substantially parallel to radiation directed at the target 90 and/or the optical axis of the collector 36, for the reasons already shown in and described with reference to FIG. 13.

The plurality of droplets 90 do not need to extend in an exact linear manner, but only a substantially linear manner. For example, a degree of offsetting (e.g., away from the optical axis 36) of droplets in the array of droplets 90 may be advantageous, for example for filling, or filling to a greater extent, the waist of laser beam 6. FIG. 15 shows how this may be achieved, either by appropriate location of the arrangement (e.g., droplet generators) used to provide the droplet streams 70, 72, and/or by appropriate synchronization of the ejecting of droplets from those droplet generators.

It will be appreciated that the shape of the target may be tailored to a particular requirement, for example a particularly preferred propagation direction of radiation and/or contamination, in combination with conversion efficient considerations. For example, there may be a preferred propagation direction for generated radiation depending on whether a radiation collector is a normal incidence collector, or a grazing incidence collector, or some other form of collector. The shape of the target can allow for the contamination to be directed in a certain direction, which may allow for such contamination to be dealt with more effectively.

In the above embodiments both the first bodies and second bodies have been described as comprising a droplet of fluid. In other embodiments, one or both bodies may be or comprise a solid material (e.g., a particle or pellet). However, it is thought that the directing of the bodies and shaping of the resulting target may be more accurately and readily achievable using droplets of fluid, as opposed to the use of solids.

In the above embodiments, the first body and second body used to form the target have been described as comprising fuel (e.g., droplets thereof) for use in generating a radiation generating plasma. However, in other embodiments only one of the bodies may comprise such a fuel, and the other body may simply be used to shape that body for use in the subsequent generation of a radiation generating plasma.

The first body and second body may be at different temperatures (e.g., at a collision location). This may be advantageous. For instance, the first body may comprise a material at a boiling temperature that is lower than a temperature of the second body. If and when the bodies collide, the collision may result in at least partial boiling of the first body, which may energize the collision, for example increasing the vapour pressure or the like, which may assist in or optimize the subsequent generation of a plasma and/or radiation therefrom. The boiling (or at least a temperature difference) may alternatively or additionally facilitate the provision of a gas film or other thin barrier between the bodies (especially if both bodies are fluidic), which may assist in the shaping of the target.

The first body and second body may comprise the same material or may comprise different materials. For instance, the first body may comprise a material that is substantially transparent to the radiation that is to be generated by the radiation generating plasma. This may be advantageous if, for example, the first body is used to shape the second body, such that the first body then does not hinder or inhibit the propagation of radiation that is generated from the resulting radiation generating plasma.

As described above, various properties of the first body and second body may be used to control the shape or make-up of the resulting target, and the orientation thereof. A third body may also be used, directed from a third, different location. The use of three bodies to form a target may allow for a greater degree of control of the orientation or the like of the resulting target.

As described above, droplet generators may be used to provide the first and second bodies. However, in some embodiments droplets may not be required. Thus, and more generally, the invention may relate to the provision of apparatus comprising a first configuration for directing a first body from a first location, together with a second configuration for directing a second body from a second, different location. The first and second configurations may not necessarily be separate pieces of apparatus, but could, for example, be different apertures in a nozzle or reservoir or the like, so long as the first body and second body are directed from and/or originate from different locations, to allow for the shaping and/or make-up configurations described above.

The locations from which the bodies originate and/or trajectories of the bodies may be fixed, or may be changeable (e.g., by moving or changing the configurations from which the bodies are directed). Similarly, the speed of the bodies may be fixed or may be changeable. If changeable, the shape or make-up of the target may be changed as and when desired, which may be useful. Active control of the locations from which the bodies originate may be used to adjust the shape or make-up of the target. Similarly, active control of the trajectories, speeds or other properties of the bodies may be used to adjust the shape or make-up of the target. The active control may take into account one or more measurements (i.e., feedback may be used). The measurements may for example be measurements of properties of generated EUV (e.g., intensity), and/or measurements of the trajectories of the bodies, and/or measurements of the shape of the target. The active control may be performed using a control apparatus (not illustrated) such as a microprocessor.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, LEDs, solar cells, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

When describing the lithographic apparatus, the term “lens”, where the context allow, may refer to any one or combination of various types of optical components, including refractive, reflective, magnetic, electromagnetic and electrostatic optical components.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims that follow.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method of generating radiation, the method comprising:
directing a first body from a first location;
directing a second body from a second location that is different from the first location, the first body and the second body being used to form a target at a plasma formation location,
wherein the first body or the second body comprises a fuel for use in generating a radiation generating plasma; and
directing initiating radiation at the target at the plasma formation location to generate the radiation generating plasma from the target.

2. The method of claim 1, wherein the first body and the second body are directed to cause a collision between the first body and the second body to form the target.

3. The method of claim 2, wherein the first body and the second body are directed such that trajectories of a center of the first body and a center of the second body substantially coincide in space and time at a collision location.

4. The method of claim 1, wherein:
the first body and the second body are directed to cause a collision between the first body and the second body;
a flattened body is formed from the collision, the flattened body forming the target; and
the initiating radiation is directed at the target such that the initiating radiation is incident on a flattened surface of the flattened body.

5. The method of claim 4, wherein the first body and the second body are directed such that the flattened surface of the flattened body extends in a direction substantially perpendicular to:
a trajectory of the initiating radiation directed at the flattened body; or
an optical axis of a radiation collector configured to collect radiation generated by the radiation generating plasma.

6. The method of claim 2, wherein the first body and the second body are directed such that trajectories of a center of the first body and a center of the second body are offset in space or time at a collision location.

7. The method of claim 6, wherein bodies that are smaller than the first body or the second body are formed from the collision, the bodies forming the target.

8. The method of claim 7, wherein the bodies are aligned in a substantially linear manner.

9. The method of claim 8, wherein the first body and second body are directed such that the bodies are aligned in a direction substantially parallel to:
a trajectory of the initiating radiation directed at the bodies; or
an optical axis of a collector configured to collect radiation generated by the radiation generating plasma.

10. The method of claim 2, wherein, with respect to the initiating radiation directed at the target, the collision forms a substantially concave target, a substantially convex target, or a substantially toroidal target.

11. The method of claim 1, wherein the first body and the second body are directed such that the target comprises the first body and the second body located substantially adjacent to one another.

12. The method of claim 1, wherein the first body and the second body are directed such that the first body and the second body at the plasma formation location are aligned in a direction substantially parallel to:
radiation directed at the first body and the second body; or
an optical axis of a collector configured to collect radiation generated by the radiation generating plasma.

13. The method of claim 1, wherein the first body or the second body comprises a droplet of fluid.

14. The method of claim 1, wherein the first body and the second body comprises a droplet of fuel for use in generating a radiation generating plasma.

15. The method of claim 1, wherein:
the first body is at a first temperature; and
the second body is at a second temperature that is different from the first temperature.

16. The method of claim 1, wherein:
the first body comprises a first material; and
the second body comprises a second material that is different from the first material.

17. The method of claim 1, wherein the first body comprises a material that has a boiling temperature that is lower than a temperature of the second body.

18. The method of claim 1, wherein the first body comprises a material that is substantially transparent to the radiation that is to be generated by the radiation generating plasma.

19. The method of claim 1, further comprising directing a third body from a third location that is different from the first location and the second location, the third body being used to form the target at the plasma formation location.

20. The method of claim 1, wherein a second implementation of the method is performed substantially simultaneously to generate a second target that forms a composite target with the target at the plasma formation location.

21. The method of claim 1, further comprising using active control of properties of the bodies to adjust the shape or make-up of the target.

22. A lithographic method comprising:
generating radiation, wherein the generating comprises
directing a first body from a first location,
directing a second body from a second location that is different from the first location, the first body and the second body being used to form a target at a plasma formation location,
wherein the first body or the second body comprises a fuel for use in generating a radiation generating plasma, and
directing initiating radiation at the target at the plasma formation location to generate the radiation generating plasma from the target; and
using the generated radiation to apply a pattern to a substrate.

23. A radiation source comprising:
a first configuration for directing a first body from a first location;
a second configuration for directing a second body from a second location that is different from the first location;
the first body and the second body used to form a target at a plasma formation location,
wherein at least one of the first body and the second body comprises a fuel for use in generating a radiation generating plasma; and
a secondary radiation source configured to direct radiation at the target at the plasma formation location to generate a radiation generating plasma from the target.

24. The radiation source of claim 23, wherein the first configuration or the second configuration comprises a droplet generator configured to generate a stream of droplets.

25. The radiation source of claim 23, further comprising a radiation collector configured to:
collect radiation generated by the radiation generating plasma at a plasma formation location; and
direct at least a portion of the generated radiation to a focal point.

26. The radiation source of claim 23, wherein the radiation source is a part of a lithographic apparatus.

27. The radiation source of claim 23, wherein the radiation source is a part of an apparatus.

28-53. (canceled)
